(19) United States
(12) Patent Application Publication
(10) Pub. No.: US 2015/0348012 A1
(43) Pub. Date: Dec. 3, 2015

(54) Systems and Methods for Managing Funds

(71) Applicant: FIRST DATA CORPORATION, Greenwood Village, CO (US)

(72) Inventor: Michael Hursta, Greenwood Village, CO (US)

(21) Appl. No.: 14/729,393

(22) Filed: Jun. 3, 2015

Related U.S. Application Data
(60) Provisional application No. 62/007,046, filed on Jun. 3, 2014.

(51) Int. Cl. G06Q 20/34; G06Q 20/28

(52) U.S. Cl. CPC G06Q 20/342; G06Q 20/28

(57) ABSTRACT

Systems, methods, and computer-readable media are disclosed for managing funds. Example methods may include receiving an indication of a monetary funds value from a merchant, the monetary funds value associated with a universal fund item. The method may include receiving an activation indication indicating that the universal fund item is activated, creating a non-allocated account in which to place monetary funds, and associating the non-allocated account with the universal fund item. The method may include receiving registration information from a user account, associating the non-allocated account with the user account, and generating a set of merchants at which monetary funds can be allocated. The method may include receiving a selection of one or more merchants at which to allocate a portion of the monetary funds, and allocating the portion to the selected merchant, such that the portion is redeemable at the selected merchant via the universal fund item.

### RELATED APPLICATIONS

This application claims the benefit of U.S. Provisional Application No. 62/007,046, filed Jun. 3, 2014.

### FIELD OF THE DISCLOSURE

The disclosure generally relates to managing funds, and more particularly relates to systems and methods for managing allocated and non-allocated funds.

### BACKGROUND

Consumers may wish to purchase prepaid cards or gift cards but may be unsure of specific merchants where they desire to use the purchased cards. Also, small businesses may not be able to compete with larger businesses in obtaining retail space for gift cards specific to the small business at, for example, gift card malls. Further, conventional systems may respond to account inquiries in situations where no updates are available.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral may identify the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 illustrates an example retailer environment in accordance with one or more example embodiments.

FIG. 2 illustrates an example electronic interface for managing accounts in accordance with one or more example embodiments.

FIG. 3 illustrates a method for managing accounts in accordance with one or more example embodiments.

FIG. 4 illustrates another method for managing accounts in accordance with one or more example embodiments.

FIG. 5 illustrates a process flow of an example method for managing accounts in accordance with one or more example embodiments.

FIG. 6 illustrates an example computer architecture of one or more computer devices in accordance with one or more example embodiments.

### DETAILED DESCRIPTION

### Overview

This disclosure is directed to systems and methods for managing funds. Broadly, certain systems and methods described herein may allow consumers to place funds, such as prepaid card or gift card funds, in a non-allocated account for later designation to specific merchants. For example, a consumer may desire to purchase a prepaid card, but may not wish to designate the funds or monetary value of the prepaid card to a specific merchant at the time of purchase. Using certain embodiments of the systems and methods described in this disclosure, the consumer may purchase a universal fund for any desired monetary value, and may not have to designate a specific merchant at which the universal fund can be used at the time the universal fund is purchased. Instead, the universal fund may be purchased by the consumer, for example from a rack at a merchant counter, and the value associated with the purchased universal fund may be placed in a non-allocated account associated with the consumer. When the consumer decides he or she desires to designate a specific merchant at which the purchased universal fund is to be used, the value of the designated amount may either be moved to an account allocated to the specific merchant, marked or flagged as allocated to the specific merchant, or may be transferred directly to the merchant upon a purchase by the consumer at the merchant. In some instances, merchants may offer incentives or promotional offers encouraging consumers to designate the merchant or otherwise encourage consumers to allocated universal funds to the merchant. The universal fund may not be limited to standard gift card or prepaid card physical sizing, and may therefore be positioned in unique and highly visible areas within retailers or merchants for consumers to view. Certain embodiments of systems and methods described herein may further facilitate management of funds.

This disclosure relates to, among other things, systems, methods, computer-readable media, techniques, and methodologies for managing funds for allocated and non-allocated monetary funds that may be used at one or more retailers or merchants. Embodiments of the disclosure may generate electronic interfaces to manage gift card monetary funds and may generate location specific recommendations for fund allocation to particular merchants. Certain embodiments may automatically push account updates based at least in part on transactional updates, which may reduce update requests sent to processors of systems of record.

One or more technical solutions can be achieved by certain embodiments of the disclosure. For example, in at least one embodiment, universal funds purchased by a consumer may be held in a non-allocated account associated with the consumer. The value of the universal funds may be designated, either wholly or in part, to specific merchants. The designated value may then be allocated to the specific merchant. The consumer may use the universal funds, for example via a mobile application or a scannable barcode, at the merchant, and the merchant may subsequently receive the funds for the transaction. In some instances, allocated funds may be transferred to the merchant upon designation by the consumer.

These and other embodiments of the disclosure will be described in more detail through reference to the accompanying drawings in the detailed description of the disclosure that follows. This brief introduction, including section titles and corresponding summaries, is provided for the reader's convenience and is not intended to limit the scope of the claims or the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Illustrative Embodiments

While some retailers may have racks of cards with selections of merchants and digital services gift cards, physical dimensions of the card racks may affect a number of cards that a retailer can include on a card rack. Accordingly, certain merchant categories, such as small businesses, or certain merchants that may be less popular than others may be left off of, or may otherwise not be included on a gift card rack. Embodiments of the disclosure may include gift card mall apparatuses that may include generically branded gift cards that may be associated with electronic or digital interfaces that facilitate management of gift cards and/or funds associated with the gift cards. For example, a gift card of the disclosure may be branded with a product brand specific to an entire mall or group of different stores, rather than to a specific merchant, giving users flexibility in redeeming gift card funds.

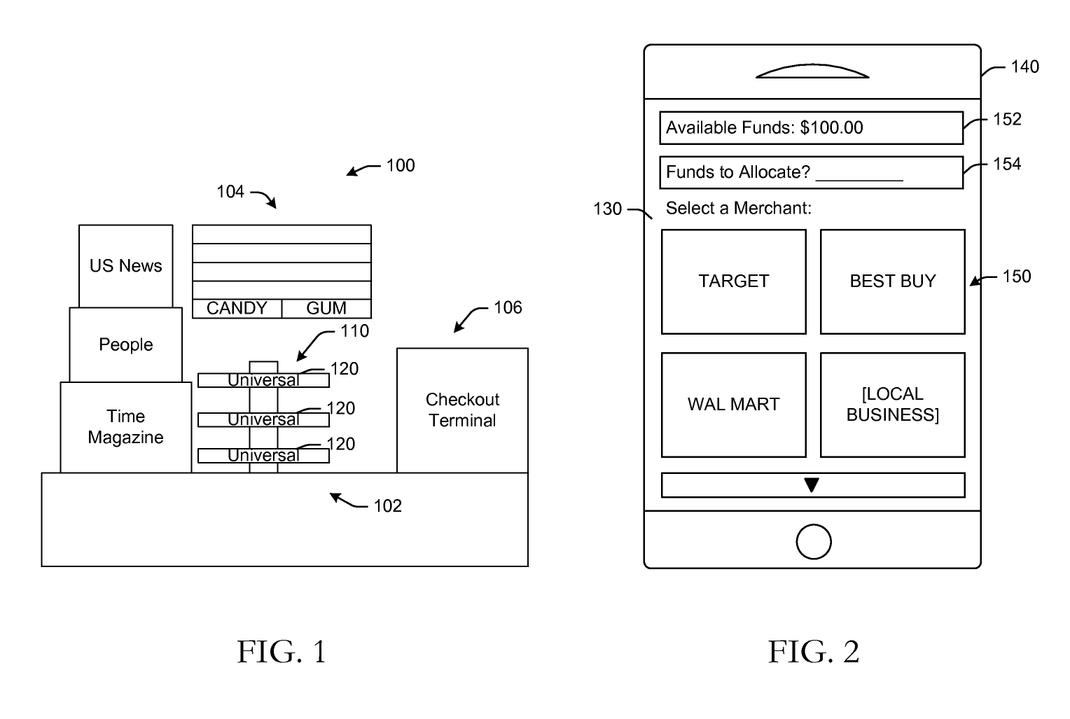

With reference now to FIG. 1, an example retailer environment 100 is illustrated according to one or more embodiments of the disclosure. The retailer environment 100 may include a merchant counter 102 with items for sale 104 on the merchant counter 102, along with a transaction terminal 106. Positioned at or near the merchant counter 102 may be a mini-mall 110 including several universal fund items 120. The mini-mall 110 may be a small rack, a j-hook, or another type of minimally invasive and unobtrusive display system that allows the universal fund items 120 to be displayed for consumers to view or browse. The universal fund items 120 may be tickets, barcodes, cards, or other items that sufficiently indicate the availability of universal funds to consumers. The mini-mall 110 may have three to six facings or more, and in other embodiments may be positioned in shopping lanes, on shopping carts, or at other locations within a retailer. The universal fund items 120 may be generically branded or may include branding of many different merchants. The universal fund items 120 may be branded with a product brand distinct to the mini-mall 110 in another embodiment.

A consumer may select a universal fund item 120 from the mini-mall 110 and purchase the universal fund item 120 for any desired value. In some instances the consumer may select any desired value, while in other instances the consumer may only be able to select predetermined value denominations, for example $25, $50, $100, or more. The consumer may pay for the universal fund item 120, thereby establishing a value or providing funds for the universal fund item 120. The merchant may accept payment for the universal fund item 120 from the consumer and the funds may later be swept from the merchant by the provider of the universal fund item 120. In another example, the funds may be automatically pushed to the provider of the universal fund item 120 upon receipt by the merchant that accepted the funds from the consumer. Upon receiving the funds, the provider of the universal fund item 120 may place the funds in a non-allocated account associated with the consumer and/or a user device associated with the consumer, as described below. The non-allocated account may hold or retain the funds for future use by the consumer, such as for designation to a specific merchant at a later point in time by the consumer.

Upon purchasing the universal fund item 120, the consumer may register the universal fund item 120 via an electronic interface. In one example, the consumer may register the universal fund item 120 via a mobile application on a mobile device, while in other examples the consumer may register via a website, text message, email, or other method. The registration process may associate the user or the mobile device, or both, with the purchased universal fund item 120 and/or the value of the purchased universal fund item 120. In some instances, the registration process or completion of the registration process may activate the universal fund item 120. Completion of the registration process may allow the consumer to access and manage the value of the universal fund item 120.

Referring now to FIG. 2, one embodiment of an electronic interface 130 is illustrated. After completing the registration process, the consumer may be associated with the universal fund item 120 and/or the value or funds associated with the universal fund item 120. The electronic interface 130 may be presented to the consumer, for example on a smartphone 140, or other device such as laptop computer, tablet, wearable device including glasses and watches, or other electronic device. The electronic interface 130 may provide the consumer with access to the universal fund items 120. For example, the consumer may be presented with a virtual catalog 150 of merchants to which the consumer may designate some or all of the available funds to. The virtual catalog 150 may include major and small businesses, allowing small businesses the opportunity to participate without having to compete for physical retail space at gift card malls. The consumer may also see available funds 152, indicating funds that are currently non-allocated and are available for the consumer to designate to a specific merchant. The electronic interface 130 may allow the consumer to select 154 a certain amount or value of the available funds in the non-allocated account to designate to a specific merchant selected from the virtual catalog. In some embodiments, the consumer may be able to select multiple specific merchants and assign a portion of the available funds to each of the specific merchants.

Upon selection or designation of funds to a specific merchant, the provider of the universal fund item 120 may allocate the funds to the specific merchant, and in some embodiments may transfer the allocated funds to an account separate from the non-allocated account, for example an account associated with the specific merchant.

The consumer, after designating a specific merchant, may proceed to purchase items or services, or make any purchase, at the designated merchant, for example using the electronic interface 130 (e.g., barcode scan, NFC or Bluetooth communication, or other electronic transaction methods) or the universal fund item 120, for example. Upon purchase, funds for the purchase may be transferred from the allocated account to the merchant in some embodiments.

In another aspect, the consumer may have available funds in the non-allocated account and may not have decided which merchant to designate the funds to. In such instances, merchants may encourage consumers to designate funds to them by providing incentives, such as bonus amounts loaded, for example by allocating $50 to a merchant, the merchant may provide the consumer with $60 in value for purchases at the merchant. Other examples of incentives include loyalty reward points, discounts on purchases, or other incentives. Incentives may be tracked via electronic interface 130 and may allow merchants to utilize intelligence in customizing incentives for specific consumers.

In another aspect, location tracking may be used, for example location of the user device 140 that includes the electronic interface 130, to prompt the consumer when the consumer or user device 140 is positioned near a merchant at which funds can be designated. For example, a consumer may have $100 in a non-allocated account. Based on the location of the consumer, determined for example by location information provided by the user device 140, the electronic interface 130 may indicate to the consumer that the consumer is near 5 merchants at which funds can be allocated, and may further present the consumer with incentives associated with each of the merchants. The consumer may therefore be reminded of the available funds and also encouraged to designate a merchant at which to allocate some or all of the non-allocated funds. Other examples of location tracking may be beacons positioned within retailers that trigger responses on the user device 140 upon entry or upon location within a retailer.

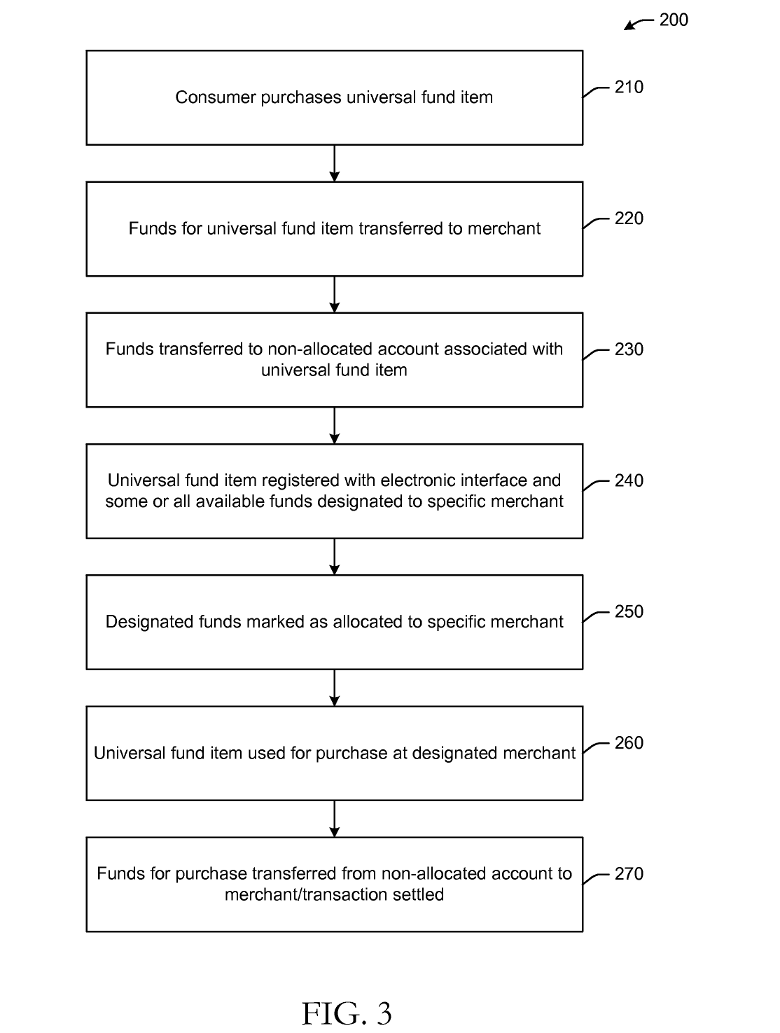

Referring to FIG. 3, an example method 200 is illustrated. At block 210, a consumer purchases a universal fund item. At block 220, the consumer transfers funds for the universal fund item to the merchant. The merchant may collect the funds from the consumer and place them in an account associated with the merchant. At block 230, the funds are transferred from the merchant to a non-allocated account associated with the universal fund item. The funds may be automatically swept from the merchant account or may be pushed by the merchant to the non-allocated account. At block 240, the consumer registers the universal fund item with an electronic interface, thereby associating the non-allocated account with the consumer. The consumer also designates a specific merchant for some or all of the funds in the non-allocated account, for example using the electronic interface. At block 250, the funds are allocated to the designated merchant, based at least in part on the designation by the consumer. At block 260, the consumer makes a purchase at the designated merchant, for example using the electronic interface. At block 270, the funds for the purchase are transferred to the merchant from the non-allocated account, or the transaction is otherwise settled.

In another aspect of this disclosure, the provider of the universal fund item 120 may be a processor that manages systems of record. The systems of record may hold the authoritative status for accounts issued from its platforms, for example the non-allocated account associated with the universal fund item 120. The systems of record may hold many data points regarding managed accounts, including current and past balances, transaction history, denomination, authorization rules, minimums and maximums, and account status. Card and account types that may be associated with the universal fund item 120 and/or the processor that manages systems of records may include prepaid accounts, private label, loyalty, incentive cards, and other cash or cashless accounts and non-monetary accounts.

Consumers increasingly digitize cards or accounts in their position, for example via mobile applications. In general, when an account is digitized, consumers wish to view up-to-date information regarding the account regularly on their electronic device. Accordingly, when an account holder is not the system of record, for example when the account holder is a financial institution, merchant, aggregator, or mobile wallet provider, the account holder keeps the consumer's account data on their portals (e.g., electronic interface) current by making frequent inquiries at the system of record. Example inquiries include recent transaction, balances, account status, and other information consumers may wish to view via the electronic interface. However, these inquiries may be initiated regularly by the account holder, even when there are no updates to be provided. Accordingly, costs associated with such inquiries are incurred by the account holder and/or the system of record.

Another aspect of this disclosure includes delivering updated account information from systems of record to account holders as changes occur to the account, or in other words, to “push” updated account information to account holders upon account changes. In some embodiments, updates may be pushed as changes to the account occur, while in other embodiments, updates may be provided in batches at frequent intervals.

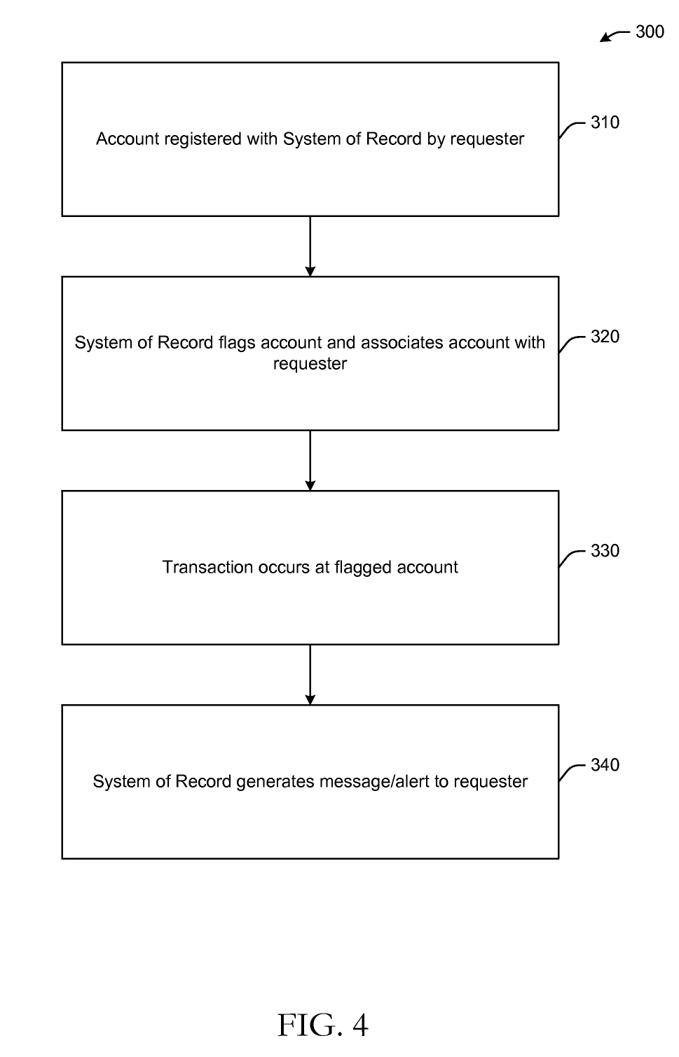

An example method 300 of this disclosure is provided in FIG. 4. At block 310, an account holder registers a specific account with the system of record, where the specific account is one that the account holder would like updates on. At block 320, the system of record receives the specific account information from the account holder and flags the specific account and associates the account with the requester, which in this case is the account holder. In some instances, the system of record may map the account to one or more electronic portals that will receive updates. At block 330, a transaction or other change occurs at the flagged account. At block 340, the system of record generates a message for distribution to all registered account holders or electronic portals. The message is transmitted to the respective account holders and in some instances, the account holders would return confirmation of receipt to the system of record, for example via a transmitted message. As discussed, the system of record may transmit messages immediately and/or individually, or at predetermined time intervals in batches.

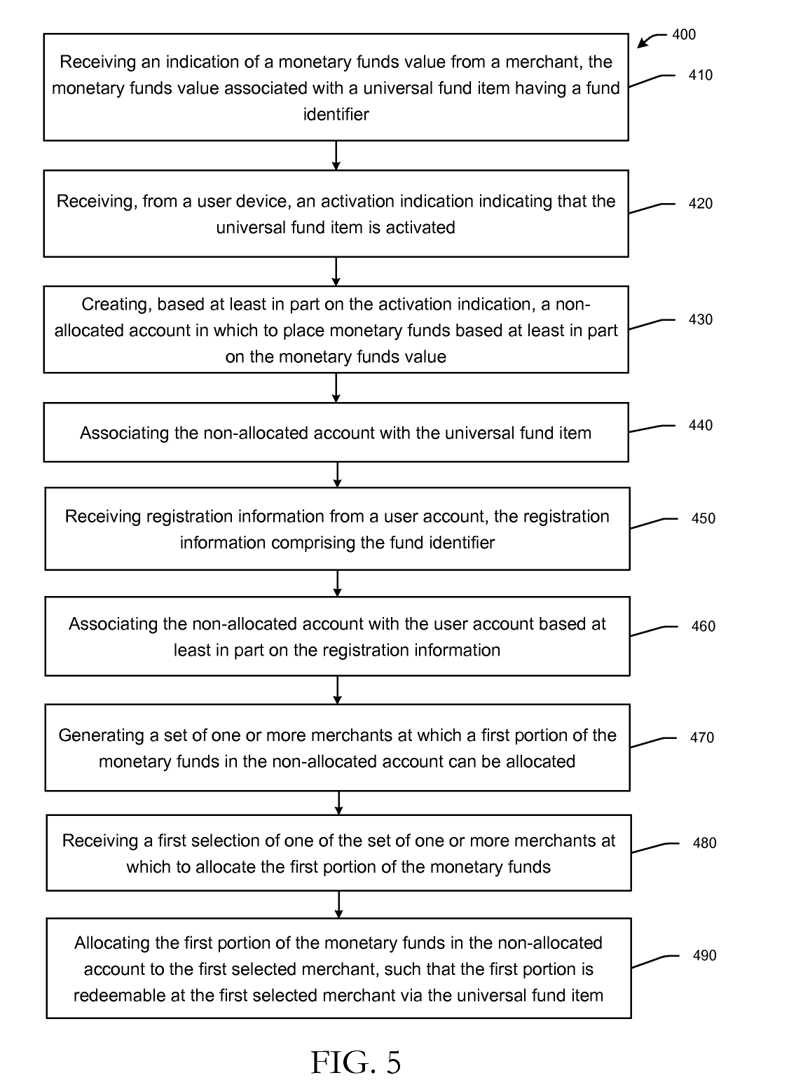

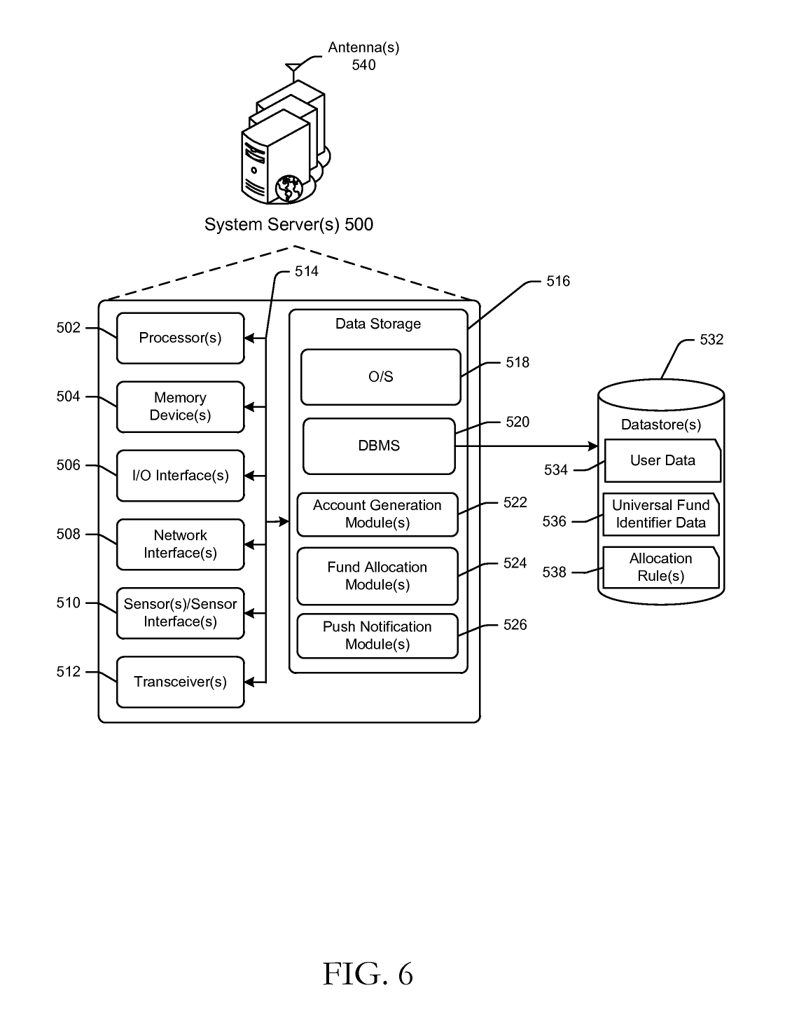

FIG. 5 is a process flow diagram of an illustrative method 400 for managing system funds in accordance with one or more example embodiments of the disclosure. Example device architecture, including modules, is illustrated in FIG. 6. At block 410 of the method 400 in FIG. 5, computer-executable instructions of one or more module(s) stored on a memory of a user device may be executed to receive an indication of a monetary funds value from a merchant device, the monetary funds value associated with a universal fund item having a fund identifier. For example, a user may obtain a gift card, which may be a universal fund item as described herein, from a gift card mall, such as the mini-mall of FIG. 1, and may purchase the gift card at a merchant device at a merchant or retailer. The merchant or retailer may input a monetary value indicative of an amount the user desires to associate with the gift card or universal fund item. A remote server or other user device may receive an indication of the monetary funds value, along with a universal fund item and fund identifier associated with the monetary funds value. The remote server or user device may store the universal fund identifier and/or associate the universal fund identifier with the monetary funds value.

At block 420 of the method 400 in FIG. 5, computer-executable instructions of one or more module(s) stored on a memory of a user device may be executed to receive, from a user device, an activation indication indicating that the universal fund item is activated. For example, upon purchasing the universal fund item and associating a monetary funds value with the universal fund item identifier, the user may desire to manage the monetary funds value via a user device or other electronic interface. The user may therefore activate the universal fund item via a mobile application, for example. The remote server may receive an activation indication from the user device and may associate one or both of the universal fund item and the monetary funds value with either user device (e.g., via a hardware identifier, etc.) and/or with a user account associated with the user of the user device.

At block 430 of the method 400 in FIG. 5, computer-executable instructions of one or more module(s) stored on a memory of a user device may be executed to create, based at least in part on the activation indication, a non-allocated account in which to place monetary funds based at least in part on the monetary funds value. For example, the remote server may create a non-allocated account for the monetary funds associated with the universal fund item and/or the user account. The remote server, in some embodiments, may facilitate transfer of the monetary funds into the created non-allocated account, for example, from a bank account or credit card associated with the user. In other embodiments, the remote server may manage or hold the monetary funds value without taking possession of the funds. The non-allocated account may be an account configured to retain or hold monetary funds or monetary fund value. Funds in the non-allocated account may be withdrawn by an authorized user in some embodiments, while in other embodiments the funds may be allocated to specific merchants or groups of merchants (e.g., malls, restaurant groups, etc.). In some embodiments, funds in the non-allocated account may be accessed after allocation of some or all of the funds.

At block 440 of the method 400 in FIG. 5, computer-executable instructions of one or more module(s) stored on a memory of a user device may be executed to associate the non-allocated account with the universal fund item. For example, the created non-allocated account may be associated with the universal fund item, such that the universal fund item can be used to access monetary funds in the non-allocated account or funds that are otherwise associated with the universal fund item.

At block 450 of the method 400 in FIG. 5, computer-executable instructions of one or more module(s) stored on a memory of a user device may be executed to receive registration information from a user account, the registration information comprising the fund identifier. For example, a user may associate a user account with the universal fund item and/or the non-allocated account via a mobile interface. Upon activation of the universal fund item, the user may register the universal fund item identifier in an electronic interface to show possession and/or ownership of funds associated with the universal fund item.

At block 460 of the method 400 in FIG. 5, computer-executable instructions of one or more module(s) stored on a memory of a user device may be executed to associate the non-allocated account with the user account based at least in part on the registration information.

At block 470 of the method 400 in FIG. 5, computer-executable instructions of one or more module(s) stored on a memory of a user device may be executed to generate a set of one or more merchants at which a first portion of the monetary funds in the non-allocated account can be allocated. For example, the user may be presented with a virtual catalog of gift card options to which funds in the non-allocated account may be allocated. The non-allocated funds may be allocated to one or more merchants. Upon allocation of funds, the user may spend or redeem the funds at the allocated merchant. Funds may be accessed or redeemed directly via a mobile device (via a bar code scan, or NFC, for example) or via the universal fund item (e.g., scannable barcode, etc.) associated with the non-allocated. Funds in or associated with the non-allocated account may not need to be allocated immediately, and can reside in the non-allocated account.

At block 480 of the method 400 in FIG. 5, computer-executable instructions of one or more module(s) stored on a memory of a user device may be executed to receive a first selection of one of the set of one or more merchants at which to allocate the first portion of the monetary funds. For example, the user may select a merchant from the virtual catalog on the electronic interface. The user may also select an amount of the non-allocated funds to allocate to the selected merchant.

At block 490 of the method 400 in FIG. 5, computer-executable instructions of one or more module(s) stored on a memory of a user device may be executed to allocate the first portion of the monetary funds in the non-allocated account to the first selected merchant, such that the first portion is redeemable at the first selected merchant via the universal fund item. In response to the user's selection, a selected amount of the funds may be allocated to the merchant, and the user may redeem or spend the funds via an electronic device or the universal fund item

In some embodiments, upon selection of a merchant for which to allocate funds, the remote server may transfer some or all of the selected portion of the monetary funds to a separate designated account associated with the selected merchant. For example, the designated account for the merchant may include aggregated funds from other users that are also allocated to the same merchant, or may be specific to the user. In some embodiments, the funds may simply be marked or designated as allocated in a state of the funds.

In one example of redeeming or spending funds, the user may scan the user device at the selected merchant point of sale. The remote server may receive a redemption request from the merchant device. The redemption request may include the fund identifier and a redemption amount indicating the amount for which the user would like to redeem funds. The remote server may determine that the universal fund identifier is associated with funds allocated to the merchant and may determine whether sufficient funds have been allocated to the merchant. If the remote server determines that the redemption amount is less than or equal to the allocated amount of monetary funds, the remote server may approve the redemption request. The remote server may, in some embodiments, process the transaction. If the remote server determines that the redemption amount is greater than the allocated monetary funds, the remote server may determine a difference between the redemption amount and the allocated funds, and may send a request or notification to the user device to allocate monetary funds equal to or greater than the difference to the merchant, such that the transaction may be processed. The user may approve the additional allocation and the remote server may receive an approval indication to allocate the difference to the merchant, and may allocate the difference to the selected merchant.

In some instances, embodiments of the disclosure may generate location-specific reminders to users for merchants at which funds have been allocated, so that the user may remember to redeem the funds. For example, the remote server may receive a geolocation of the user device, for example via GPS, and may determine that the geolocation is within a predetermined radius (e.g., such as walking distance (0.5 miles, etc.) or driving distance (5 miles, etc.) of a merchant location of a merchant. The remote server may send the user device a redemption notification indicating that the first portion of the monetary funds is allocated to the first selected merchant. The user device may receive the notification and the user may be reminded of the fund availability.

In some instances, embodiments of the disclosure may generate location-specific recommendations for merchants at which funds in a non-allocated account may be allocated. When approaching or entering a merchant's premises, for example, a user may receive an invitation on their mobile device to commit the non-allocated funds to a gift card for the merchant who they just entered. The remote server may receive a geolocation of the user device, and may determine that the geolocation is within a predetermined radius of a merchant location for which gift cards are available. The remote server may send the user device an allocation notification requesting allocation of a portion of the monetary funds to the merchant.

Merchants may also provide incentives to consumers to pick their gift card program over others. Those incentives could include bonus amounts loaded, loyalty reward points, and other popular promotional items. For example, the remote server may send the user device an incentive notification comprising a promotional offer associated with the second merchant.

As consumers store more of their prepaid, loyalty, and other payment accounts information in mobile wallets or electronically, users may desire to receive frequent account updates or notifications. Account information, such as a balance, a transaction history, and other account status information may be presented in real time in certain embodiments. Embodiments of the disclosure may deliver account data directly to the user as soon as relevant new updates or transactions are detected on a host of record for flagged accounts, thereby reducing or removing a need to continuously request account update information.

Embodiments of the disclosure may monitor accounts for updates or changes to current and past balances, transaction history, denomination, authorization rules, minimums & maximums, and card status such as active, closed, expired, etc. Embodiments of the disclosure may push account update information upon occurrence, either immediately or in batches that occur in frequent intervals. As transactional activity or other status changes take place to flagged accounts, the remote server may generate a message for distribution to all registered wallets or account holders. In an example process, the remote server may receive a registration request for example from a user device, where the registration request includes the fund identifier and a request to push account update information to the user device. In response to the request, the remote server may designate the non-allocated account as a flagged account based at least in part on the fund identifier. Upon determining that a transaction associated with the non-allocated account has occurred, the remote server may generate a push notification based at least in part on the transaction. The push notification may include an account update for the non-allocated account. The remote server may push notification to the user device. The remote server may receive a confirmation notification indicating that the push notification was received by the user device.

Using the embodiments described herein, consumer funds may be associated with a non-allocated account, thereby allowing consumers flexibility in designating a specific merchant at which to spend funds. Merchants may provide incentives to consumers to allocate available funds to the merchant. Merchants may utilize real-time loyalty marketing programs to drive sales. The embodiments of systems and methods described above may assist merchants in encouraging consumers to hold balances on accounts associated with the merchant. Account holders, such as financial institutions, may also receive real-time account information updates rather than frequently making inquiries at a system of record, thereby reducing actual and transactional costs for each involved party.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

One or more operations of the methods or use cases may have been described above as being performed by a user device, or more specifically, by one or more program modules, applications, or the like executing on a device. It should be appreciated, however, that any of the operations of methods or use cases may be performed, at least in part, in a distributed manner by one or more other devices, or more specifically, by one or more program modules, applications, or the like executing on such devices. In addition, it should be appreciated that processing performed in response to execution of computer-executable instructions provided as part of an application, program module, or the like may be interchangeably described herein as being performed by the application or the program module itself or by a device on which the application, program module, or the like is executing. While the operations of the methods or use cases may be described in the context of the illustrative devices, it should be appreciated that such operations may be implemented in connection with numerous other device configurations.

The operations described and depicted in the illustrative method and use cases may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1-5 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

### Illustrative Device Architecture

FIG. 6 is a schematic block diagram of an illustrative user device 500 in accordance with one or more example embodiments of the disclosure. The user device 500 may include any suitable computing device including, but not limited to, a mobile device such as a smartphone, tablet, e-reader, wearable device, or the like; a desktop computer; a laptop computer; a content streaming device; a set-top box; or the like. The user device 500 may correspond to an illustrative device configuration for the user devices or remote servers described herein.

The device 500 may be configured to communicate via one or more networks (not shown) with one or more servers, user devices, or the like. Such network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the device 500 may include one or more processors (processor(s)) 502, one or more memory devices 504 (generically referred to herein as memory 504), one or more input/output (“I/O”) interface(s) 506, one or more network interfaces 508, one or more sensors or sensor interfaces 510, one or more transceivers 512, and data storage 516. The device 500 may further include one or more buses 514 that functionally couple various components of the device 500. The device 500 may further include one or more antennas 540 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The bus(es) 514 may include at least one of a system bus, a memory bus, an address bus, or a message bus, and may permit exchange of information (e.g., data (including computer-executable code), signaling, etc.) between various components of the device 500. The bus(es) 514 may include, without limitation, a memory bus or a memory controller, a peripheral bus, an accelerated graphics port, and so forth. The bus(es) 514 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 504 of the device 500 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 504 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 504 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 516 may include removable storage and/or non-removable storage including, but not limited to, magnetic storage, optical disk storage, and/or tape storage. The data storage 516 may provide non-volatile storage of computer-executable instructions and other data. The memory 504 and the data storage 516, removable and/or non-removable, are examples of computer-readable storage media (CRSM) as that term is used herein.

The data storage 516 may store computer-executable code, instructions, or the like that may be loadable into the memory 504 and executable by the processor(s) 502 to cause the processor(s) 502 to perform or initiate various operations. The data storage 516 may additionally store data that may be copied to memory 504 for use by the processor(s) 502 during the execution of the computer-executable instructions. Moreover, output data generated as a result of execution of the computer-executable instructions by the processor(s) 502 may be stored initially in memory 504, and may ultimately be copied to data storage 516 for non-volatile storage.

More specifically, the data storage 516 may store one or more operating systems (O/S) 518, one or more database management systems (DBMS) 520, and one or more program modules, applications, or the like such as, for example, one or more account generation module(s) 522, one or more fund allocation module(s) 524, and one or more push notification module(s) 526. Any of the program modules may include one or more sub-modules. Any of the modules depicted in FIG. 6 may include computer-executable code, instructions, or the like that may be loaded into the memory 504 for execution by one or more of the processor(s) 502. Further, any data stored in the data storage 516 may be loaded into the memory 504 for use by the processor(s) 502 in executing computer-executable code. In addition, any data potentially stored in one or more datastore(s) 532 may be accessed via the DBMS 520 and loaded in the memory 504 for use by the processor(s) 502 in executing computer-executable code. In the illustrated example, the datastore(s) 532 may include user data 534, such as user account and user device information. The datastore(s) 532 may include universal fund identifier data 536, which may include universal fund identifiers, associations with fund accounts, associations with user accounts, and other information. The datastore(s) 532 may include one or more allocation rule(s) 538, which may be used, for example, by the fund allocation module(s) 524 to allocate funds.

The processor(s) 502 may be configured to access the memory 504 and execute computer-executable instructions loaded therein. For example, the processor(s) 502 may be configured to execute computer-executable instructions of the various program modules of the user device 500 to cause or facilitate various operations to be performed in accordance with one or more embodiments of the disclosure. The processor(s) 502 may include any suitable processing unit capable of accepting data as input, processing the input data in accordance with stored computer-executable instructions, and generating output data. The processor(s) 502 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 502 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 502 may be capable of supporting any of a variety of instruction sets.

Referring now to functionality supported by the various program modules depicted in FIG. 6, the account generation module(s) 522 may include computer-executable instructions, code, or the like that responsive to execution by one or more of the processor(s) 502 may perform functions including, but not limited to, generating non-allocated accounts and/or merchant or user specific accounts. The fund allocation module(s) 524 may include computer-executable instructions, code, or the like that responsive to execution by one or more of the processor(s) 502 may perform functions including, but not limited to, allocating some or all funds to a specific merchant. The fund allocation module(s) 524 may further include computer-executable instructions, code, or the like that responsive to execution by one or more of the processor(s) 502 verifies available funds upon redemption. The push notification module(s) 526 may include computer-executable instructions, code, or the like that responsive to execution by one or more of the processor(s) 502 may perform functions including, but not limited to, flagging accounts and generating push notifications upon detecting an account update.

Referring now to other illustrative components depicted as being stored in the data storage 516, the O/S 518 may be loaded from the data storage 516 into the memory 504 and may provide an interface between other application software executing on the device 500 and hardware resources of the device 500. More specifically, the O/S 518 may include a set of computer-executable instructions for managing hardware resources of the device 500 and for providing common services to other application programs (e.g., managing memory allocation among various application programs). In certain example embodiments, the O/S 518 may control execution of the other program modules to dynamically enhance characters for content rendering. The O/S 518 may include any operating system now known or which may be developed in the future including, but not limited to, any server operating system, any mainframe operating system, or any other proprietary or non-proprietary operating system.

The DBMS 520 may be loaded into the memory 504 and may support functionality for accessing, retrieving, storing, and/or manipulating data stored in the memory 504 and/or data stored in the data storage 516. The DBMS 520 may use any of a variety of database models (e.g., relational model, object model, etc.) and may support any of a variety of query languages. The DBMS 520 may access data represented in one or more data schemas and stored in any suitable data repository including, but not limited to, databases (e.g., relational, object-oriented, etc.), file systems, flat files, distributed datastore(s) in which data is stored on more than one node of a computer network, peer-to-peer network datastore(s), or the like. In those example embodiments in which the device 500 is a mobile device, the DBMS 520 may be any suitable light-weight DBMS optimized for performance on a mobile device.

Referring now to other illustrative components of the device 500, one or more input/output (I/O) interfaces 506 may be provided that may facilitate the receipt of input information by the device 500 from one or more I/O devices as well as the output of information from the device 500 to the one or more I/O devices. The I/O devices may include, for example, one or more user interface devices that facilitate interaction between a user and the device 500 including, but not limited to, a display, a keypad, a pointing device, a control panel, a touch screen display, a gesture capture or detection device, a remote control device, a microphone, a speaker, and so forth. The I/O devices may further include, for example, any number of peripheral devices such as data storage devices, printing devices, and so forth.

The device 500 may further include one or more network interfaces 508 via which the device 500 may communicate with any of a variety of other systems, platforms, networks, devices, and so forth. Such communication may occur via any of the types of networks previously described.

The antenna(s) 540 may include any suitable type of antenna depending, for example, on the communications protocols used to transmit or receive signals via the antenna(s) 540. Non-limiting examples of suitable antennas may include directional antennas, non-directional antennas, dipole antennas, folded dipole antennas, patch antennas, multiple-input multiple-output (MIMO) antennas, or the like. The antenna(s) 540 may be communicatively coupled to one or more transceivers 512 or radio components to which or from which signals may be transmitted or received.

As previously described, the antenna(s) 540 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(s) 540 may additionally, or alternatively, include a Wi-Fi antenna configured to transmit or receive signals in accordance with established standards and protocols, such as the IEEE 802.11 family of standards, including via 2.4 GHz channels (e.g. 802.11b, 802.11g, 802.11n), 5 GHz channels (e.g. 802.11n, 802.11ac), or 80 GHZ channels (e.g. 802.11ad). In alternative example embodiments, the antenna(s) 540 may be configured to transmit or receive radio frequency signals within any suitable frequency range forming part of the unlicensed portion of the radio spectrum.

The antenna(s) 540 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The transceiver(s) 512 may include any suitable radio component(s) for—in cooperation with the antenna(s) 540—transmitting or receiving radio frequency (RF) signals in the bandwidth and/or channels corresponding to the communications protocols utilized by the device 500 to communicate with other devices. The transceiver(s) 512 may include hardware, software, and/or firmware for modulating, transmitting, or receiving—potentially in cooperation with any of antenna(s) 540—communications signals according to any of the communications protocols discussed above including, but not limited to, one or more Wi-Fi and/or Wi-Fi direct protocols, as standardized by the IEEE 802.11 standards, one or more non-Wi-Fi protocols, or one or more cellular communications protocols or standards. The transceiver(s) 512 may further include hardware, firmware, or software for receiving GNSS signals. The transceiver(s) 512 may include any known receiver and baseband suitable for communicating via the communications protocols utilized by the device 500. The transceiver(s) 512 may further include a low noise amplifier (LNA), additional signal amplifiers, an analog-to-digital (A/D) converter, one or more buffers, a digital baseband, or the like.

The sensor(s)/sensor interface(s) 510 may include or may be capable of interfacing with any suitable type of sensing device such as, for example, inertial sensors, force sensors, motion sensors, thermal sensors, cameras, and so forth. Example types of inertial sensors may include accelerometers (e.g., MEMS-based accelerometers), gyroscopes, and so forth. In one example, the user devices described herein may include a motion sensor configured to detect an event corresponding to device motion via the motion sensor. Such events may be continuous motion for a certain length of time, which may indicate that the user device is not stationary (e.g., the user using the user device is in a car, etc.).

It should be appreciated that the program modules, applications, computer-executable instructions, code, or the like depicted in FIG. 6 as being stored in the data storage 516 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the device 500, and/or hosted on other computing device(s) accessible via one or more networks, may be provided to support functionality provided by the program modules, applications, or computer-executable code depicted in FIG. 6 and/or additional or alternate functionality. Further, functionality may be modularized differently such that processing described as being supported collectively by the collection of program modules depicted in FIG. 6 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 6 may be implemented, at least partially, in hardware and/or firmware across any number of devices.

It should further be appreciated that the device 500 may include alternate and/or additional hardware, software, or firmware components beyond those described or depicted without departing from the scope of the disclosure. More particularly, it should be appreciated that software, firmware, or hardware components depicted as forming part of the device 500 are merely illustrative and that some components may not be present or additional components may be provided in various embodiments. While various illustrative program modules have been depicted and described as software modules stored in data storage 516, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Program modules, applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A method comprising:
receiving, by a computer system comprising one or more processors, an indication of a monetary funds value from a merchant device, the monetary funds value associated with a universal fund item having a fund identifier;
receiving, by the computer system from a user device, an activation indication indicating that the universal fund item is activated;
creating, by the computer system and based at least in part on the activation indication, a non-allocated account in which to place monetary funds based at least in part on the monetary funds value;
associating, by the computer system, the non-allocated account with the universal fund item;
receiving, by the computer system, registration information from a user account, the registration information comprising the fund identifier;
associating, by the computer system, the non-allocated account with the user account based at least in part on the registration information;
generating, by the computer system, a set of one or more merchants at which a first portion of the monetary funds in the non-allocated account can be allocated;
receiving, by the computer system, a first selection of one of the set of one or more merchants at which to allocate the first portion of the monetary funds; and
allocating, by the computer system, the first portion of the monetary funds in the non-allocated account to the first selected merchant, such that the first portion is redeemable at the first selected merchant via the universal fund item.

2. The method of claim 1, further comprising:
transferring, by the computer system, some or all of the first portion of the monetary funds to a first designated account associated with the first selected merchant.

3. The method of claim 1, further comprising:
receiving, by the computer system, a second selection of one of the set of one or more merchants at which to allocate a second portion of the monetary funds; and
allocating, by the computer system, the second portion of the monetary funds to the second selected merchant.

4. The method of claim 1, further comprising:
receiving, by the computer system, a redemption request from the first selected merchant, the redemption request comprising the fund identifier and a redemption amount;
determining, by the computer system, that the first portion of the monetary funds is allocated to the first selected merchant; and
approving, by the computer system, the redemption request.

5. The method of claim 4, further comprising:
determining, by the computer system, that the redemption amount is less than or equal to the first portion of the monetary funds.

6. The method of claim 4, further comprising:
determining, by the computer system, that the redemption amount is greater than the first portion of the monetary funds;
determining, by the computer system, a difference between the redemption amount and the first portion; and
prompting the user to allocate monetary funds equal to the difference to the first selected merchant.

7. The method of claim 6, further comprising:
receiving, by the computer system, an approval indication to allocate the difference to the first selected merchant; and
allocating, by the computer system, the difference to the first selected merchant.

8. The method of claim 1, further comprising:
receiving, by the computer system, a geolocation of the user device;
determining, by the computer system, that the geolocation is within a predetermined radius of a merchant location of the first selected merchant; and
sending, by the computer system, the user device a redemption notification indicating that the first portion of the monetary funds is allocated to the first selected merchant.

9. The method of claim 1, further comprising:
receiving, by the computer system, a geolocation of the user device;
determining, by the computer system, that the geolocation is within a predetermined radius of a merchant location of a second merchant of the set of one or more merchants; and
sending, by the computer system, the user device an allocation notification requesting allocation of a second portion of the monetary funds to the second merchant.

10. The method of claim 9, further comprising:
sending, by the computer system, the user device an incentive notification comprising a promotional offer associated with the second merchant.

11. The method of claim 1, further comprising:
receiving, by the computer system, a registration request from the user device, the registration request comprising the fund identifier and a request to push account update information to the user device;
designate, by the computer system, the non-allocated account as a flagged account based at least in part on the fund identifier;
determining, by the computer system, that a transaction associated with the non-allocated account has occurred;
generating, by the computer system, a push notification based at least in part on the transaction, the push notification comprising an account update for the non-allocated account; and
pushing, by the computer system, the push notification to the user device.

12. The method of claim 11, further comprising:
receiving, by the computer system, a confirmation notification indicating that the push notification was received by the user device.

13. A server, comprising:
at least one memory storing computer-executable instructions; and
at least one processor communicatively coupled to the at least one memory and the display and configured to access the at least one memory and execute the computer-executable instructions to:
receive an indication of a monetary funds value from a merchant, the monetary funds value associated with a universal fund item having a fund identifier;
receive, from a user device, an activation indication indicating that the universal fund item is activated;
create, based at least in part on the activation indication, a non-allocated account in which to place monetary funds based at least in part on the monetary funds value;
associate the non-allocated account with the universal fund item;
receive registration information from a user account, the registration information comprising the fund identifier;
associate the non-allocated account with the user account based at least in part on the registration information;
generate a set of one or more merchants at which a first portion of the monetary funds in the non-allocated account can be allocated;
receive a first selection of one of the set of one or more merchants at which to allocate the first portion of the monetary funds; and
allocate the first portion of the monetary funds in the non-allocated account to the first selected merchant, such that the first portion is redeemable at the first selected merchant via the universal fund item.

14. The device of claim 13, wherein the at least one processor is further configured to execute the computer-executable instructions to:
transfer some or all of the first portion of the monetary funds to a first designated account associated with the first selected merchant.

15. The device of claim 13, wherein the at least one processor is further configured to execute the computer-executable instructions to:
receive a second selection of one of the set of one or more merchants at which to allocate a second portion of the monetary funds; and
allocate the second portion of the monetary funds to the second selected merchant.

16. The device of claim 13, wherein the at least one processor is further configured to execute the computer-executable instructions to:
receive a redemption request from the first selected merchant, the redemption request comprising the fund identifier and a redemption amount;
determine that the first portion of the monetary funds is allocated to the first selected merchant; and
approve the redemption request.

17. The device of claim 16, wherein the at least one processor is further configured to execute the computer-executable instructions to:
determine that the redemption amount is greater than the first portion of the monetary funds;
determine a difference between the redemption amount and the first portion; and
prompt the user to allocate monetary funds equal to the difference to the first selected merchant.

18. The device of claim 13, wherein the at least one processor is further configured to execute the computer-executable instructions to:
receive a geolocation of the user device;
determine that the geolocation is within a predetermined radius of a merchant location of the first selected merchant; and
send the user device a redemption notification indicating that the first portion of the monetary funds is allocated to the first selected merchant.

19. The device of claim 13, wherein the at least one processor is further configured to execute the computer-executable instructions to:
receive a geolocation of the user device;
determine that the geolocation is within a predetermined radius of a merchant location of a second merchant of the set of one or more merchants; and
send the user device an allocation notification requesting allocation of a second portion of the monetary funds to the second merchant.

20. The device of claim 13, wherein the at least one processor is further configured to execute the computer-executable instructions to:
receive a registration request from the user device, the registration request comprising the fund identifier and a request to push account update information to the user device;
designate the non-allocated account as a flagged account based at least in part on the fund identifier;
determine that a transaction associated with the non-allocated account has occurred;
generate a push notification based at least in part on the transaction, the push notification comprising an account update for the non-allocated account; and
push the push notification to the user device.
